(19) United States
(12) Patent Application Publication
(10) Pub. No.: US 2003/0236874 A1
(43) Pub. Date: Dec. 25, 2003

(54) Method and arrangement for providing an information management system

(76) Inventor: Timo Hotti, Lohja (FI)

Correspondence Address: YOUNG & THOMPSON, 745 SOUTH 23RD STREET 2ND FLOOR, ARLINGTON, VA, 22202

(21) Appl. No.: 10/160,108

(22) Filed: Jun. 4, 2002

(51) Int. Cl. G06F 15/173

(52) U.S. Cl. 709/224

(57) ABSTRACT

The invention is in the area of scalable real time service usage monitoring and billing for wireless smart network infrastructures such as 3G networks. The invention relates to a method and an arrangement for collecting large amounts of service usage data from large number of sources for large number of subscribers. This data can be used for example for real time Quality of Service monitoring and usage-based service billing purposes. Especially the invention relates to a method and an arrangement for network data management, where at least one personal dedicated database is arranged for a user and where service usage information of said user is managed by said personal master database. Further, the invention addresses the problem of matching the usage monitoring data with the subscriber profiles.

### TECHNICAL FIELD

The invention relates to a method and an arrangement for providing a distributed and scaleable information management system in a data network. Especially the invention relates to managing and monitoring service usage data of network infrastructures.

### BACKGROUND OF THE INVENTION

The following notions are used in this application:

“Data element” is an information structure, which can comprise other data elements or such data elements, which can be construed as atomary data elements. For instance, in a relational database data elements are represented by tables comprising rows. The rows comprise columns, which are typically atomary data elements.

“Database” is an information structure, which comprises one or more data elements, and the use of which is controlled by a database management system. The invention is applicable both in relational databases and in databases of other forms, such as in object oriented databases.

“Database Server” is a software process that manages the data of at least one database and through which applications can access and modify the data of the database. Database server is often referred to also as Database Management System (DBMS).

“Database operation” is an event, during which data elements are read from the database, during which data elements of the database are modified, during which data elements are removed from the database, or during which data elements are added to the database.

“Database Catalogue” is a logical database within a database instance. A physical database can manage data of multiple database catalogues. Each database catalogue can act as a master or replica database node in a database synchronization environment.

“Database Schema” is the structure of a logical database, described in a formal language supported by the database management system (DBMS). In a relational database, the schema defines the tables, the columns in each table, and the relationships between columns and tables.

“Master database” is a logical database in a database synchronization system that contains the official version of a set of possibly distributed data. The master database may have zero or multiple replica databases in the network.

“Network” is especially a wireless smart network, such as 3G network or local area network but as well it may be any other kind of wireless or wired information network. However, the network is such that it can be implemented to work in a telecommunication system, which is compliant with at least one of the following: TCP/IP, CDMA, GSM, HSCSD, GPRS, WCDMA, EDGE, Bluetooth, UMTS, Teldesic, Iridium, Inmarsat, WLAN, DIGI-TV, and imode.

“Replica database” is a logical database in a database synchronization system that contains a full or partial copy of the master data.

“Synchronization” is the operation between replica and master database catalogues in which changed data is exchanged between the catalogues. In one known embodiment, this means propagation of Intelligent Transactions from replica to master and/or subscribing to at least one publication to download changed data from master to replica, [1].

“Push synchronization” is synchronization between replica and master database catalogues initiated by the master database server.

“Publication” is a set of data in a database catalogue that has been published in master database for synchronization to one or multiple replica databases. A publication can contain parameters that are used to filter data of the publication.

“Transaction” is a plurality of database operations acting on the data elements. A transaction is an atomic operation that is completed or discarded as a whole. A transaction can also comprise further transactions.

“User” or subscriber may be an individual subscriber of at least one service or alternatively a small group comprising few subscribers that can be treated as one user or group.

Different kinds of information management and monitoring solutions are used in modern data communication systems and networks for monitoring usage of services provided by the nodes of a network. Information management solutions are used for example for managing and monitoring service usage statistics, usage recording and pricing, billing account management and fraud control. These conventional information management systems according to the prior art are typically implemented by one or multiple centralized databases in the Operation Support Systems of telecommunication or data networks.

There is disclosed a prior art for network session management in U.S. Pat. No. 6,137,869 providing a scalable internetwork telephony solution, where each Internet telephone service subscriber will have at least one billing and authorization account maintained in a database on the Internet. According to the solution described in U.S. Pat. No. 6,137,869 usage recording, pricing, and authorization for the overall network are bundled into a single logical database, which may be physically distributed.

Further a subscriber information management system is known from the abstract of Japanese publication JP2000102075, where an information database management device is used for managing an information database corresponding by one to one or one to multiple to respective subscribers in order to exchange encrypted information. A purpose of this solution is to enhance the security of a communication network by allowing the 1st radio station to request the 1st encryption key possessed by the 2^{nd} radio station via 1^{st} and 2^{nd} base stations and to receive the 1^{st} encryption key approved by 1^{st} and 2^{nd} certificates issued by each base station.

There are, however, some disadvantages in the prior art methods. Most usage monitoring systems according to the known prior art are relying on a single centralized database that has become a performance and feature bottleneck of the system. For example, today's billing systems are suitable actually only for batch-oriented billing of relatively few services. In addition problems appear with the prior art solutions when need arises for real time billing of potentially large number (e.g. hundreds or thousands) of personalizable services for each user of the network system. That is because the resources of centralized database aren't enough for real time billing or managing and monitoring of exploding number of services in the telecommunication and data networks.

Additionally, there is also need for more subscriber centric service today considering the preferences and profile of the subscriber. For example, the rating of a service may depend on the individual billing plan of the subscriber as well as on the current usage context, but however, there is no sophisticated, manageable and scalable arrangement in prior art for implementing this. Further there is clear necessity for real time monitoring of usage data, for allowing usage of comprehensive user preference and profile data and for fine-grained usage-based billing of network services and content. However, the current centralized architectures are not able to solve these problems because the transaction processing capacity is limited by the capacity of a single server computer.

### SUMMARY OF THE INVENTION

The object of the invention is to simplify and make more flexible and profitable managing and monitoring processes of service usage data of large number of users of different services in the telecommunication and data networks. The invention aims also to real time monitoring of service usage data of users and also real time billing of large number of personalized services for each user and fine-grained usage-based billing of network services and contents. In addition the object of the invention is to allow usage of comprehensive user preference and profile data. The further object of the invention is to fulfil the need for more subscriber centric service considering the preferences and profiles of the user.

The objects of the invention are fulfilled providing at least one user of a network system with at least one logical personal database dedicated to the user such that service usage data from different sources are collected to the personal database and collected service usage data and user's profile data are managed by the personal database. In addition the objects of the invention are achieved by allowing scalability of number of the personal databases in real time as a function of number of the users.

A user or a subscriber in this document should be treated as an individual subscriber of a service or alternatively a small group comprising few subscribers that can be treated as one user or group, that shares at least some common items in the subscriber profile. A small group can also be the entity that receives the invoice of using the services. In addition a group can be for example members of family or employees of a corporation

According to one embodiment of the present invention a logical personal database may be created for a new user when the new user is added to a data network system.

A partial replica copy of the personal database may be created when a user affiliates a new service. The purpose of this replica database is to provide the service provider relevant parts of the subscriber's profile and collect information about the usage of the service for billing, Quality of Service (QoS) and other purposes. According to the invention logical databases may also be removed when a user is removed from the data network system or alternatively when a user terminates a subscribed service definitively. Thus the numbers of personal databases of users may be varied linearly with varying numbers of users or services subscribed by users. In addition it should be noticed that according to the present invention the databases may be created anywhere. Partial or full replica copies of the database may be distributed to potentially large number of computers and servers, whereupon problems, such as overloading, which arise when using one centralized database, may be avoided.

After preparing at least one master database and at least one replica database to the user, network service usage data, such as Quality of Service statistics, location information, from different sources may be collected to the databases. These databases may contain also information relevant to the user, such as user's profile data, user preferences, and user-specific service rating. The master databases may be hosted for example by the network operator or other trusted party who is the primary maintainer of the subscriber preference data and also the primary user of the collected usage data, whereupon the network operator or other trusted party may generate invoices, Quality of Service (QoS) reports etc. of the user based on the data of the user's database.

The personal master database dedicated to the user can be partially copied to any number of remote database servers called “usage record collectors”. There can also be one or multiple usage record collectors in the network who access and modify directly the data of the personal master databases. Each of these usage record collectors is affiliated with at least one network node that can produce usage records for the subscriber. Such network node can be for example IP Edge Router, Phone Switch or an e-business server. The preference data may be downloaded from the subscriber's master databases to the replica databases of the usage record collectors using data synchronization or other reliable data transfer techniques. The usage records that have been created based on the occurred service usage and subscriber's profile data are transferred from the replica databases to the subscriber's master databases using similar techniques. Further according to one embodiment of the present invention each of the user's smart terminals can host a copy of the user's profile data, whereupon the user can self-provision his service portfolio for example by manipulating his profile data at the terminals and later synchronizing it with the subscriber's master database. Alternatively the user may self-provision his service portfolio by accessing the data of the master database and manipulating his profile data through an authorized set of services. Any changes or at least the applicable part of the modified data in the subscriber's master database may then be automatically pushed using data synchronization to the record collector servers of network nodes who provide the services that the subscriber uses.

Data delivering, such as synchronization, may be implemented by a direct connection between master and replica databases or alternatively data may be transferred between the servers using a content routing mechanism. Such mechanism is sometimes beneficial in optimization of delivery of large number of typically small synchronization messages between large number of master and replica databases. The content routing mechanism is a network of edge and core content routers. Each master and replica database is connected to at least one edge content router. The edge content routers are connected to advantageously several core content routers. The core content routers may be connected to other core content routers and possibly to a number of edge content routers. This arrangement makes a network of interconnected routers that is capable of passing messages between databases in an optimised manner. In addition to these connection-based data transfer mechanisms connectionless data transfer mechanisms such as e-mail can be used to transfer data between the databases.

The configuration, i.e. database schema and applications, and security material of the subscriber and record collector databases may be managed for example by a separate configuration management system, which is disclosed in another U.S. patent application [2] filed by Solid.

The methods and arrangements in accordance with the invention are especially suited for scalable real time service usage monitoring and billing for wireless smart network infrastructures, such as 3G networks.

The invention relates to a method for network data management, where at least one user has at least one personal master database dedicated to the user, which is characterized in that at least some of the service usage data of said user is managed by said personal master database.

The invention further relates to a network data management arrangement comprising at least one user with at least one personal dedicated master database, which is characterized in that said personal master database is arranged to manage at least some of the service usage data of said user.

The invention further relates to a database server comprising at least one personal dedicated master database for a dedicated user, which is characterized in that said personal master database is arranged to manage at least some of the service usage data of said user.

The best mode of the invention is considered to be providing at least one user of a network system by at least one personal master database dedicated to the user, managing the profile data of the subscriber in this database, making relevant parts of the profile data available to sources of service usage data advantageously using data synchronization techniques, collecting service usage data from these sources to the database and using collected service usage data in the personal database in order to allow scalable real time service usage monitoring and billing for telecommunication and data network infrastructures, such as wireless 3G networks.

Some embodiments of the invention are described in the dependent claims.

### BRIEF DESCRIPTION OF THE DRAWINGS

Next the invention will be described in greater detail with reference to exemplary embodiments in accordance with the accompanying drawings, in which:

FIG. 1a illustrates a flow diagram of exemplary steps for maintaining a scalable database arrangement according to one embodiment of the present invention,

FIG. 1b illustrates a flow diagram of exemplary steps for maintaining a scalable database arrangement according to another embodiment of the present invention,

FIG. 1c illustrates a flow diagram of exemplary steps for maintaining a scalable database arrangement according to another embodiment of the present invention,

FIG. 2 illustrates a flow diagram of exemplary steps for maintaining a user database according to one embodiment of the present invention,

FIG. 3 illustrates a block diagram of an exemplary arrangement for delivering data between the user databases, usage record collector server and source of usage records according to one embodiment of the present invention,

FIG. 4 illustrates a block diagram of an exemplary arrangement for delivering data between the user database, several usage record collector servers and sources of usage records according to one embodiment of the present invention,

FIG. 5 illustrates a block diagram of an exemplary hierarchy of user databases, usage record collector servers and sources of usage records according to one embodiment of the present invention,

FIG. 6 illustrates a block diagram of an exemplary arrangement for arranging data inside the database servers according to one embodiment of the present invention,

FIG. 7 illustrates a block diagram of an exemplary arrangement for providing the configuration of the whole arrangement comprising at least user database, record collector service and source of usage records according to one embodiment of the present invention,

FIG. 8 illustrates a block diagram of an arrangement for self-provisioning user's service portfolio by the user according to one embodiment of the present invention, and

FIG. 9 illustrates a block diagram of an exemplary arrangement for providing a data delivering by utilizing a content routing mechanism according to one embodiment of the present invention.

### DETAILED DESCRIPTION

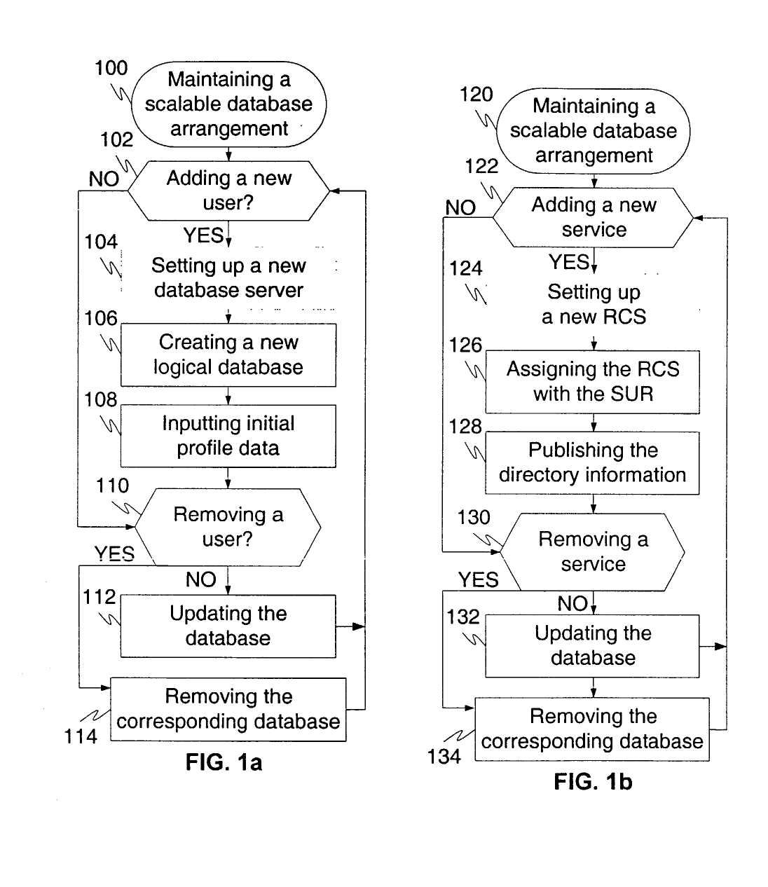

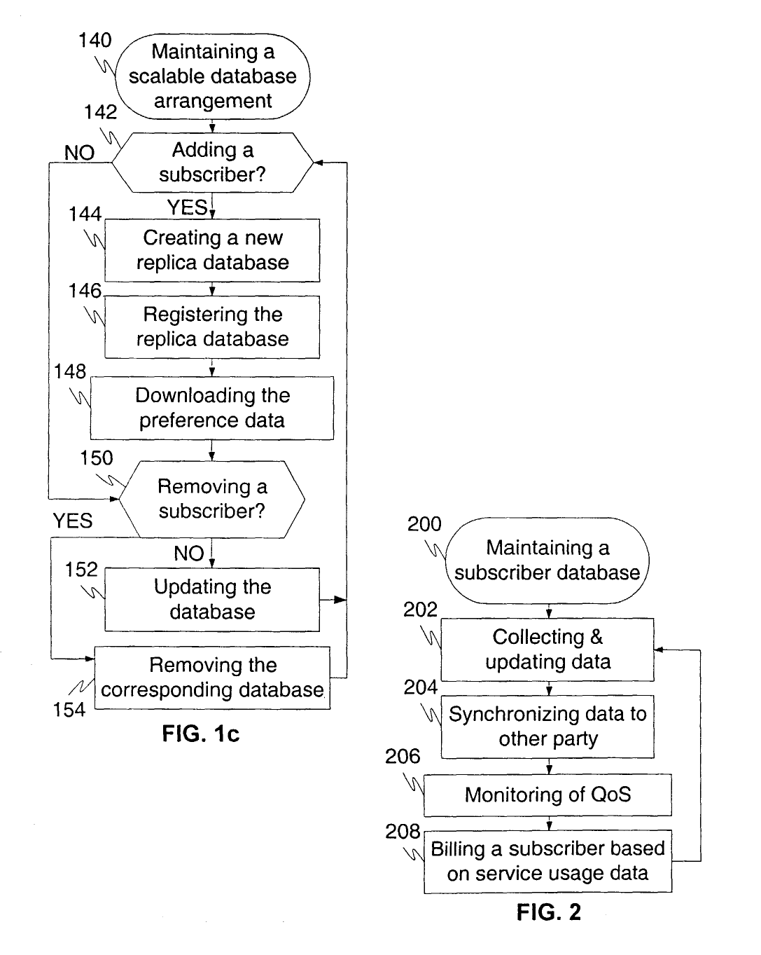

FIG. 1a illustrates a flow diagram of exemplary steps for maintaining 100 a scalable database arrangement according to one embodiment of the present invention, where a new user can be added and/or created to a network system in step 102 for example by an operator or other trusted party of a telecommunication or data network system. Further an administrator or the like of the data network may carry out an analysing process for analysing the managed telecommunication or data network in step 102 in order to detect possible new users or alternatively the administrator may also be informed in step 102 about the new users. The administrative tasks may also be fully automated so there may not be a need for an administrator at all.

If any new user is detected the administrator may set up a new database server in step 104 if a suitable one does not exist yet or by another reason. However, step 104 is optional. In step 106 the administrator may create a new personal logical master database to the new user. Also at least one partial or full replica copy of the database may be created to the user for example when the user is a subscriber of some services or it otherwise seems to be necessary by some reason. According to one embodiment of the invention a personal master database may also be created and prepared for small group of users that can be treated as one group or one user.

After creating at least one new personal database to the user the database may be updated in step 108 by inputting initial profile data into the database and maintained by an appropriate data, such as data, which is relevant to the user or service subscribed by the user. Data may concern for example user preferences, profile, user specific service rating or information about user's terminals, information about terminal address or number, bandwidth, desired bandwidth in different time of day or the like. The data can be typically collected from other parties or elements in the network.

An essential part of the user's master database is typically formed by the user's profile data, which can be at least partly synchronized to the usage data record collector servers relating to the services subscribed by the user. The profile data may also affect the content of usage data to be collected and also the way of collecting the data such as a frequency when a Quality of Service (QoS) is monitored for the user. The profile data may, for example, contains at least one piece of computer executable program that performs at least one data collection or processing task in the personal master database or record collector server.

Step 110, where possible removals of the users are determined, is performed after step 108, but it may be performed also right after step 102 if no new user was added or found in the data network. Also now the administrator or the like may perform an analysing process for analysing the managed telecommunication or data network in order to detect possible removals of the users. Alternatively the administrator may also be informed in step 110 about the removed users. If a removed user is detected in step 110 the administrator may remove the user's personal database in step 114 corresponding to the removed user. If no removed users were found in the data network in step 110, the existing databases of the users may be updated in step 112, which may also be optional. The updated data relates typically to the user's profile, preferences, service usage data or the like.

When the databases corresponding to the removed users are removed in step 114 or alternatively step 112 is performed, at least part of steps 102-114 may be performed again. Further it should be noticed that the order of steps 102-114 illustrated in FIG. 1a is exemplary and the order is not restricted to the order shown in FIG. 1a.

FIG. 1b illustrates a flow diagram of exemplary steps for maintaining 120 a scalable database arrangement according to another embodiment of the present invention, where a new service can be added and/or created to a network system in step 122 for example by an operator or other trusted party of a telecommunication or data network system. Again further an administrator or the like of the data network may carry out an analysing process for analysing the managed telecommunication or data network in step 122 in order to detect possible new services or alternatively the administrator may also be informed in step 122 about the new services. In some cases, the administrative functions may be fully automated, so a separate system administrator may not be needed.

If any new service is detected the administrator may set up a new usage record collector server (RCS) in step 124 if one does not exist yet or by another reason. However, step 124 is optional. In step 126 the administrator may assign the RCS with at least one service that is called here a source of usage records (SUR), after which the directory information of the new service may be published in step 128 for example in the network so that subscribers can find the service. Step 130, where possible removals of the services are determined, is performed after step 128, but it may be performed also right after step 122 if no new service was added or found in the data network. Also now the administrator or the like may perform an analysing process for analysing the managed telecommunication or data network in order to detect possible removals of the services. Alternatively the administrator may also be informed in step 130 about the removed services. If removed service is detected in step 130 the administrator may free or remove from the corresponding usage record collector server the corresponding databases, assignments and/or sources of usage record in step 134. If no removed services were found in the data network in step 130, the existing replica databases of the RCSs of the services may be updated in step 132 by appropriate data, such as preferences and profile data of the users subscribing the service and service usage data. This update is advantageously done by synchronizing the replica databases of the RCS with the users' master databases. Step 132 may also be optional.

When the databases and assignments corresponding the removed services are removed in step 134 or alternatively step 132 is performed, at least part of steps 122-134 may be performed again. Further it should be noticed that the order of steps 122-134 illustrated in FIG. 1b is exemplary and the order is not restricted to the order shown in FIG. 1b.

FIG. 1c illustrates a flow diagram of exemplary steps for maintaining a scalable database arrangement according to third embodiment of the present invention, where a new subscriber can be added to use a service in a network system in step 142 for example by an operator or other trusted party of a service or telecommunication or data network system. Further an administrator or the like of the service/data network system may carry out an analysing process for analysing the managed service, telecommunication or data network system in step 142 in order to detect possible new subscribers or alternatively the administrator may also be informed in step 142 about the new subscribers of the service. In some cases, the administrative functions may be fully automated, so a separate system administrator may not be needed.

If any new subscriber is detected the administrator may create at least one new replica database to the subscriber in the usage record collector server of the service in step 144, register the replica database with the subscriber's master database in step 146 and download relevant part of the subscriber's preference information to the replica database in step 148 using advantageously data synchronization or other reliable data transfer techniques. Also a new usage record collector server may be set up in step 144 for the new replica databases if one does not exist yet or by another reason. The usage record collector server may be a separate server or alternatively it may also be embedded into the service arrangement (source of usage records) in the network system.

Step 150, where possible removals of the subscribers of the services are determined, is performed after step 148, but it may be performed also right after step 142 if no new subscriber was added or found in the service or data network system. Also now the administrator or the like may perform an analysis process for analysing the managed service, telecommunication or data network system in order to detect possible removals of the subscribers of the services. Alternatively the administrator may also be informed in step 150 about the removed subscribers. If removed subscriber is detected in step 150 the administrator may remove the corresponding replica databases in step 154. If no removed subscribers were found in the service or data network system in step 150, the existing replica databases of the subscribers of the services may be updated in step 152 by an appropriate data such as preferences and profile data of the users subscribing the service and service usage data. Step 152 may also be optional.

When the replica databases corresponding the removed subscriber of the services are removed in step 154 or alternatively step 152 is performed, at least part of steps 142-154 may be performed again. Further it should be noticed that the order of steps 142-154 illustrated in FIG. 1c is exemplary and the order is not restricted to the order shown in FIG. 1c.

FIG. 2 illustrates a flow diagram of exemplary steps for maintaining 200 a personal master database according to one embodiment of the present invention. When the personal master database is created, it may be populated with some initial data, such as initial identity information of a user. In addition other appropriate data, such as updateable profile data, may be collected in step 202 to the master database.

The appropriate data may depend on the user, for whom the database is created, such as also on the services subscribed by the user. Thus the data may be information relating for example to user preferences, profile, quality of service requirements and user specific service rating, but also information relating to services subscribed by the user. The data may also be information about subscriber's terminals, such as information about terminals address or number, IP-number, bandwidth, bandwidth in different time of day or the like.

The data collected in step 202 may also be service usage data, which is collected from large number of sources, such as IP Edge Routers, Phone or Telecom Switch, or e-business servers. The service usage data is collected typically through at least one replica database but it may be sent to the master database directly from the source. The data may be collected also from subscriber's terminals, such as mobile phone, computer, digital television, personal digital assistant (PDA), modem, LAN card, DSL box or the like. In addition the data collected to the databases may be used for example for modifying user preferences and/or profiles in order to categorize the user into specific category or categories.

The profile data of the user may also affect the content of usage data to be collected and/or updated in step 202 and also the way of collecting the data such as a frequency when a Quality of Service (QoS) is monitored for the user or what actions to take if the QoS level desired by the user is not met.

The collected data and user's profile data is stored to the user's master database, but the data may be delivered in step 204 at least partly also to other parties or elements of data network or even data warehouses, which are relevant in relation to the user, his preferences and/or profiles. The other parties or elements in the data network may typically be replica databases of database servers of usage record collectors relating to the services subscribed or used by the user. The elements may comprise at least one replica database corresponding at least partly the user's master database. According to one embodiment of the invention the master database can be at least partially copied also to computers that generate service usage monitoring transactions for the user.

Data and transactions between the databases are typically delivered using data synchronization techniques but other methods of reliable data transfer known by a person skilled in the art can be applied as well. Further it should be noticed that delivered data may be encrypted for example using disposable keys assigned by the master according to the method disclosed in another U.S. patent application [3] filed by Solid.

In step 206 the collected usage data may for example be used for real time Quality of Service monitoring in order to detect for example state of network or possible defects in the data network, such as bit rate, breaks or overloads in the data transferring and also the rating information of the used service. The Quality of Service monitoring may monitor for example a certain service, data network or subscriber or alternatively also some combination of services, data networks, users and/or subscribers. In addition the collected usage data may be used for billing purposes of the users in step 208.

In addition the invention allows also fine-grained usage based billing of network services and contents, whereupon each users and/or services subscribed by the users may have own charge or tariff. Further the Quality of Service (QoS), bit rate and other information related to the individual user or service subscribed by the user may also be considered when billing the subscriber. In addition according to the invention the billing may be performed in real time, because the service usage data may be collected continuously. Further it should be noticed that the order of steps 202-208 are not restricted to the order illustrated in FIG. 2 and the steps 204, 206 and 208 may be performed only in need. Furthermore the step 202 may be performed numbers of times consecutively before any other steps 204-208.

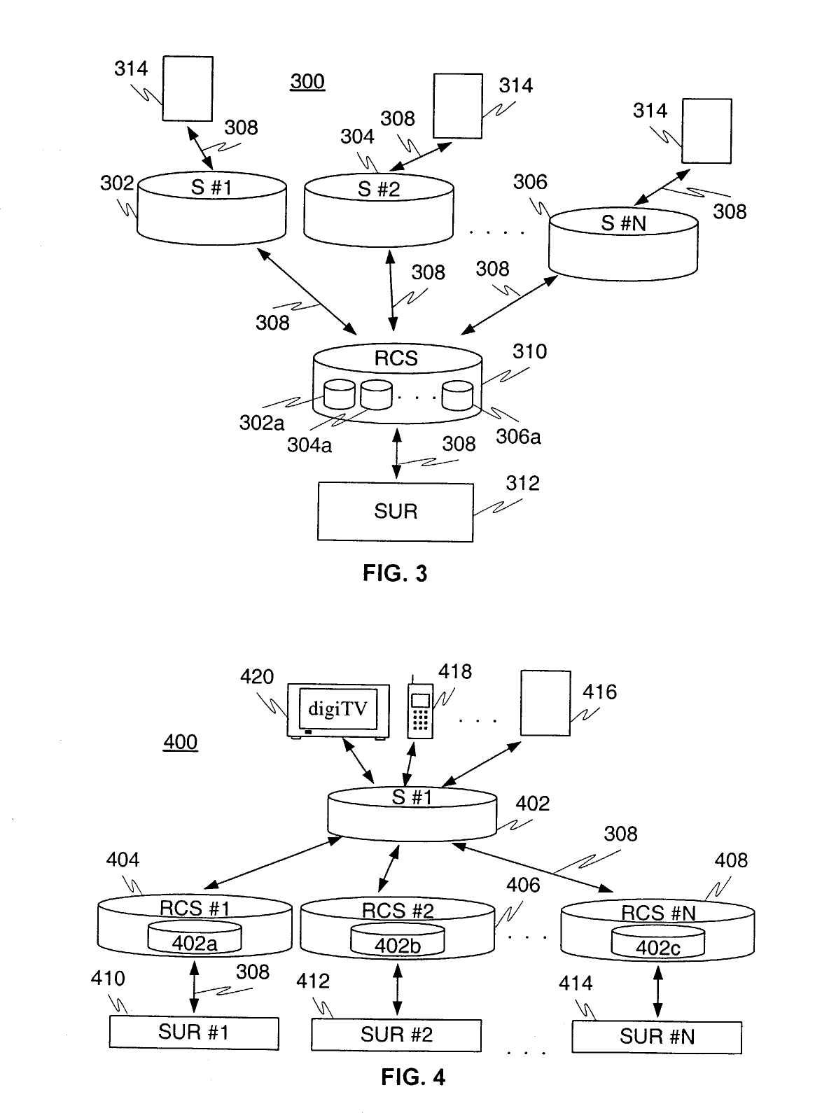

FIG. 3 illustrates a basic idea of an exemplary arrangement 300 for delivering data between user databases 302, 304, 306, usage record collector server 310 (RCS) and source 312 of usage records (SUR) according to one embodiment of the present invention. The personal master databases 302. 304, 306 dedicated to the subscribers may be hosted by a primary user of the databases, such as a network operator or other trusted party and further the personal master databases 302, 304, 306 may be arranged in data communication with several elements of the information network 308, whereupon data, such as service usage data from different sources, can be collected to the databases 302, 304, 306 for immediate or later use. In addition it should be noticed that the personal master databases 302, 304, 306 can be basically hosted anywhere in a trusted place, such as in a network operator server, subscriber's server or even in a subscriber's terminal 314 or in an arrangement of service provider. The subscriber's terminal 314 may be for example a DSL box, modem, WLAN card, mobile phone or digital television.

The personal master databases 302, 304, 306 may communicate with the replica database of the usage record collector server 310. The usage record collector server 310 is typically arranged in data communication 308 also with source 312 of usage records, which can be a network element, such as a Telecom s itch or an intelligent Edge Router. The usage record collector server 310, which can generate for example service usage transactions for the subscriber, may be embedded in the SUR itself or it can be a separate computer residing close to the SUR. The source of usage records 312 may be for example an IP Edge Router, Phone Switch or an e-business server.

According to one embodiment of the invention at least part of each subscriber's master databases 302, 304, 306, such as user's profile data, may be delivered and copied into replica databases 302a, 304a, 306a maintained by the usage record collector server 310. The user's profile data may contain also pieces of software that the usage record collector server or personal master database may use to collect and process the usage data. The number of the replica databases 302a, 304a, 306a at the usage record collector server 310 may be increased or decreased in real time as a function of subscribers or master databases 302, 304, 306 of different subscribers for providing a scalable arrangement. Each of the replica databases 302a, 304a, 306a correspond at least partly corresponding subscriber master database 302, 304, 306, whereupon different kinds of statistic information, for example, may be computed easier and faster.

Further if the content of the subscriber's master database 302, 304, 306 are manipulated or if any changes occur in the subscriber master database 302, 304, 306, at least the changes may be automatically delivered to other appropriate network elements and the usage record collector server 310 providing the subscriber's service. The delivering process, such as transactions, may be performed for example using synchronization, but other methods of data transfer know by man skilled in the art can be applied as well. Furthermore the transactions or other delivered data may be encrypted for example using disposable keys assigned by the master according to the method disclosed in another U.S. patent application [3] filed by Solid. The encryption may be performed e.g. by the usage record collector servers. The master databases 302, 304, 306 of subscribers typically contain all the information that is relevant to the subscriber. The replica databases 302a, 304a, 306a may contain a copy of some or all of this information, such as for example subscriber preferences and service rating specific to the subscriber and this service. When the user uses a service, the service inserts usage records to the replica database of the user in the record collector server. Later the records are propagated to the user's master database using data synchronization or other reliable data transfer technique. Thus for example real time Quality of Service (QoS) monitoring and reports and usage based billing can be performed based on the data collected to the subscriber master database 302, 304, 306 from the corresponding replica database 302a, 304a, 306a. Especially the databases comprise subscribers profile data, which may also affect to the content of usage data to be collected and also to way of collecting the data such as a frequency when a Quality of Service (QoS) is monitored for the user.

The databases 302, 304, 306 and 302a, 304a, 306a may also comprise data concerning the subscriber's terminal 314, such as data relating to address or number of the terminal 314, data relating to line speed and using time, data relating to QoS in different time, such as information about the status, condition or state of the service or terminal at different time. The QoS may also be a notion of possible bit rate at different time of day or a notion of possible overloads and breaks in the data transferring or the rating information of the used service.

In an exemplary embodiment of the invention illustrated in FIG. 3 each subscriber 302, 304, 306 are arranged to use same service, such as an ADSL service (ADSL terminal 314), whereupon relevant information or service usage records concerning each subscriber is delivered between the usage record collector server 310 and corresponding subscriber's database 302, 304, 306. The relevant information may concern for example rating information of the ADSL service of individual user or amount of transferred bytes to and/or from the subscriber's ADSL terminal. In the embodiment of FIG. 3 the usage record collector server 310 or at least part of it is arranged to be an ADSL usage record collector server.

Although in the arrangement 300 each subscriber has own logical and personal master database 302, 304, 306, the individual subscriber may also have more than one database, for example in a situation when the subscriber has several profiles for different tasks and he uses services for example in different situations or places, such as home, school or work. Alternatively one database may be generated and prepared also for small group comprising few users that can be treated as one user or subscriber, such as administrators, secretaries and staff in a company.

According to one embodiment of the invention, the usage record collector 310 may also access and modify the data of the personal master database 302, 304, 306 directly. In such case, the replica database in the usage record collector server may not be needed for that user. This is feasible if a user accesses a particular service only once or very seldom.

In addition it should be noticed, that the usage record collector server 310 and/or sources 312 of usage records may be separated elements or alternatively at least part of them may also be embedded into the service arrangement in the network system.

FIG. 4 illustrates a block diagram of an exemplary arrangement 400 for delivering data through a data communication network 308 between a subscriber personal master database 402, several terminals 416, 418, 420, several usage record collector servers 404, 406, 408 and sources 410, 412, 414 of usage records according to one embodiment of the present invention. The arrangement 400 illustrated in FIG. 4 is typical, when the subscriber 402 has several terminals 416, 418, 420 and he uses several different services. The services subscribed by the user is advantageously compatible with the used terminals 416, 418, 420, which may be for example a DSL box, modem, WLAN card, mobile phone, digital television or the like.

Data concerning each service used by the subscriber is collected to the subscriber's personal master database 402 from each usage record collector server 404, 406, 408 separately, which usage record collector servers 404, 406, 408 are arranged in data communication also with separated sources 410, 412, 414 of usage records corresponding each service. The data to be collected to the subscriber's master database 402 may be collected also from the subscriber's terminals 416, 418, 420 and again delivered to the usage record collector servers 404, 406, 408. The data, such as subscriber's profile data, is delivered to the usage record collector servers 404, 406, 408 advantageously so that each usage record collector server collects, monitors and maintains data relating only the service maintained by the server.

The usage record collector servers 404, 406, 408 may maintain replica databases 402a, 402b, 402c concerning at least partly the subscriber's personal master database 402, where each of the replica databases 402a, 402b, 402c typically comprises only data relating to a particular service subscribed by the subscriber. The replica databases 402a, 402b, 402c may comprise copy of the subscriber personal master database 402 or only the relevant part of the master database 402, such as subscriber's profile data. As an example the usage record collector server 404 may relate to digital television services, whereupon the replica database 402a maintained by the server 404 relates to digital television service of the subscriber and comprises only service usage and profile data related to the digital television service of the subscriber. The replica database 402a may comprise also data concerning the digital television terminal 420 of the subscriber.

According to FIG. 4 each usage record collector servers 404, 406, 408 may collect and maintain usage information relating to its 404, 406, 408 own role, and transfer synchronization or other reliable data transfer techniques. After receiving the usage data from the RCS, the applications operating on the data of the master database can act upon the data, for example invoice the subscriber in real time.

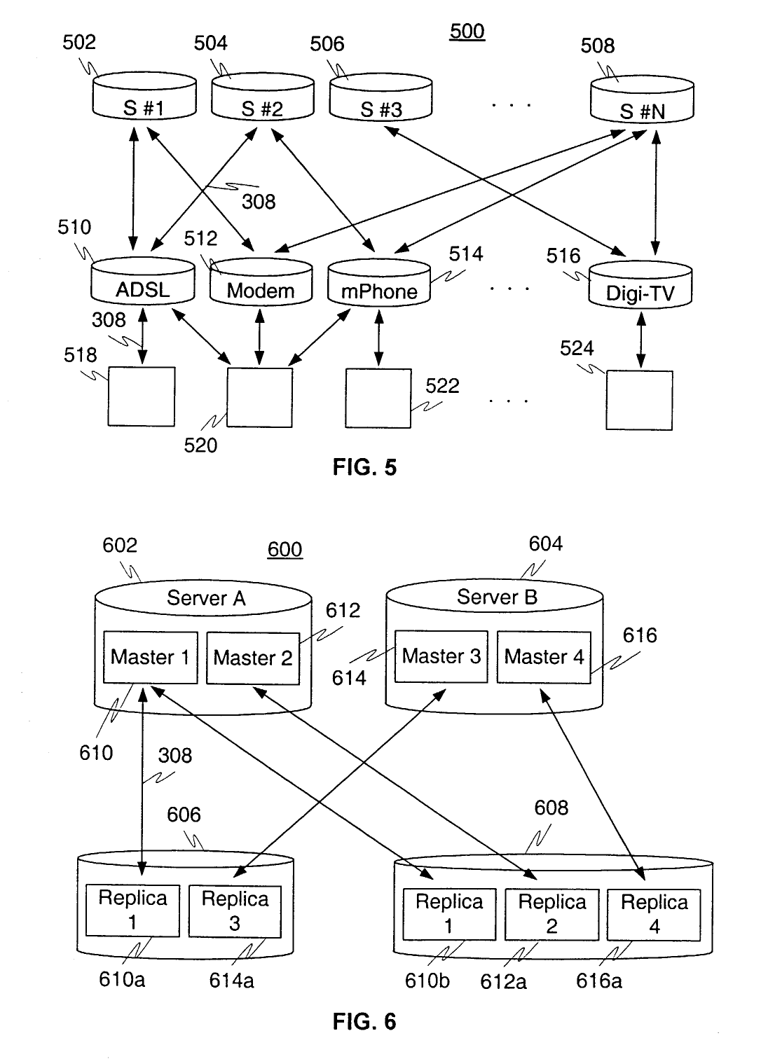

FIG. 5 illustrates a block diagram of an exemplary hierarchy of large numbers of personal master databases 502, 504, 506, 508 of subscribers, usage record collector servers 510, 512, 514, 516 and sources 518, 520, 522, 524 of usage records and an exemplary arrangement 500 for delivering data through a data communication network 308 between these elements according to one embodiment of the present invention. According to the arrangement 500 each of the subscribers may have several different kinds of terminals (not shown in FIG. 5) and services they use, whereupon each usage record collector server 510, 512, 514, 516 monitor several subscribers or subscriber databases 502, 504, 506, 508 simultaneously and maintain at least partly corresponding replica databases (not shown in FIG. 5) in the appropriate usage record collector server. In addition each of the usage record collector servers 510, 512, 514, 516 may synchronize data relating to role of the usage record collector server from the subscribers master databases 502, 504, 506, 508 through a data communication network 308 using for example data synchronization.

As an example the user record collector server 510 in FIG. 5 may be for example an ADSL usage record collector server, the usage record collector server 512 may be arranged for dialup modems, the user record collector server 514 may be arranged for mobile phones and the user record collector server 516 may be arranged for digital televisions, whereupon each user record collector server may create and maintain at least one replica database corresponding to the personal master databases 502, 504, 506, 508 of the subscribers and collect only data concerning the role or function of said server. Each of the user record collector servers has also at least one source 518, 520, 522, 524 of usage records, but according to one embodiment of the invention some user record collector servers may communicate with multiple sources of usage records.

In an exemplary FIG. 5 the first subscriber (S#1) may use for example an ADSL box or service and card modem, whereupon his master database 502 collects, monitors and maintains usage data concerning the first subscriber's ADSL and dialup modem service. Similarly the second (S#2) subscriber may use for example an ADSL service and mobile phone service, third subscriber (S#3) may use for example only digital television service and last subscriber (S#4) may use for example dialup modern mobile phone and digital television services. Now the personal master database 504 of the second subscriber collects, monitors and maintains usage data concerning the second subscriber's ADSL and mobile phone, personal master database 506 of the third subscriber collects, monitors and maintains usage data concerning to the third subscriber's digital television and personal master database 508 of the last subscriber collects, monitors and maintains usage data concerning to the last subscriber's card modem, mobile phone and digital television, respectively.

Again the user record collector server 510 maintains at least replica databases of the users of the ADSL service, synchronizes relevant user profile information from the users' master databases and collects usage data relating to this service. In FIG. 5 the user record collector server 510 contains at least partial replica databases from databases 502 and 504. Respectively the user record collector server 512 maintains replica databases (from databases 502 and 508 in FIG. 5) of the users and collects usage data relating to dialup modem service. Furthermore the user record collector server 514 maintains at least partial replica databases (from databases 504 and 508 in FIG. 5) of the users of the mobile phone service and collects usage data relating to this service. Further the user record collector server 516 maintains replica databases (from databases 506 and 508 in FIG. 5) and collects data relating to digital television service.

However, it should be noticed, that there are no restrictions for numbers of subscriber, subscriber databases, service usage record collector servers and/or sources of usage records. Especially the number of subscribers and subscriber databases may differ from number of usage record collector servers and be for example much larger than number of usage record collector servers or sources of usage records.

In addition it should be noticed, that the usage record collector servers 510, 512, 514, 516, sources 518, 520, 522, 524 of usage records and/or even personal master databases 502, 504, 506, 508 of the subscribers may be separated elements, maintained by an administrator of the network or alternatively at least part of them may also be embedded into and maintained by the service provider's system in the data network.

FIG. 6 illustrates a block diagram of an exemplary arrangement 600 for arranging data inside database servers 602, 604, 606, 608 according to one embodiment of the present invention. The servers 602, 604 dedicated for subscribers comprise a separate personal logical database, or database catalogue, for master data of at least one individual subscriber of the system and the usage record collector servers 606, 608 comprise a separate replica catalogue for at least one subscriber who use the service.

The servers 602, 604 may at least in principle be located anywhere in the data network and they may be operated and maintained for example by the network operator or other trusted party, who is the primary user of the collected usage data. Further the subscriber master databases or at least a part of them, such as subscriber's profile data, can be distributed to potentially large number of computers and/or servers 602, 604, whereupon problems, such as overloading, which arise when using one centralized database, may be avoided.

The replica databases 610a, 610b, 612a, 614a, 616a corresponding the master databases 610, 612, 614, 616 are created and maintained at the usage record collector servers 606, 608, which may be operated and maintained for example by the network elements and/or computers, that generate service usage records for the subscribers. An example about such network element is for example an IP Edge Router, Phone Switch or an e-business server. The usage record collector servers are typically dedicated for a certain service, such as ADSL, card modem, mobile phone and digital television services.

Again it should be noticed that the servers 606, 608 may at least in principle locate anywhere in the data network and the replica databases can be distributed to potentially large number of computers and/or servers 606, 608, whereupon problems, such as overloading, which arise when using one centralized database, may be avoided. The usage record collector servers 606, 608 or usage record sources may be embedded for example into the service provider's system (not shown in FIG. 6).

As an example the usage record collector server 606 or at least part of it may be dedicated for ADSL services and the usage record collector server 608 for digital television services, whereupon at least part of the server 606 collects service usage data and maintains databases relating only to ADSL services and at least part of the server 608 collects service usage data and maintains databases relating only to digital television service.

In FIG. 6 the subscriber of the master database 610 is arranged to use ADSL and digital television services, whereupon a replica database 610a corresponding at least the ADSL part of the subscriber's personal master database 610 is maintained at the usage record server 606 arranged for ADSL services and a replica database 610b corresponding at least the digital television part of the subscriber's personal master database 610 is maintained at the usage record server 608 arranged for digital television services. Further the subscribers of master databases 612, 614 and 616 are arranged to use either ADSL or digital television service, whereupon they have a replica database 612a, 614a, 616a only in one usage record collector server 606, 608.

Again the servers 602, 604, 606, 608 and databases 610, 610a, 610b, 612, 612a, 614, 614a, 616, 616a may be arranged to deliver data between other elements through a data communication network 308 using for example data synchronization, but other methods of data transfer known to a person skilled in the art can be applied as well. However, it should be noticed that data could be delivered only between a master and at least one corresponding replica database, but not preferably between master and replica databases of different subscribers. For instance the master database 610 can't synchronize transactions with other databases than its own replica databases 610a and 610b. Further it should be noticed that transactions or other delivered data may be encrypted for example using disposable keys assigned by the master according to the method disclosed in another U.S. patent application [3] filed by Solid.

In addition the servers 602, 604, 606, 608 may be arranged to scale the number of databases as a function of number of users using the service and maintain databases distributed to potentially large number of servers. Further the database servers may be arranged to be in data connection with at least one of the following means: usage record collector server, IP Edge Router, Phone or Telecom Switch and e-business servers.

The database servers 602, 604, 606, 608 may be provided in a terminal, which may be for example a mobile station, a server computer, a workstation, terminal connected with modem, LAN card or DSL service, personal digital assistant and digital television and the terminal has at least one of the following operating systems: Unix, MS-windows, EPOC, NT, MSCE, Linux, PalmOS and GEOS. Further it should be noticed that the database servers 602, 604, 606, 608 and the data communication network 308 may be compatible with at least one of the following communication specifications: TCP/IP, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

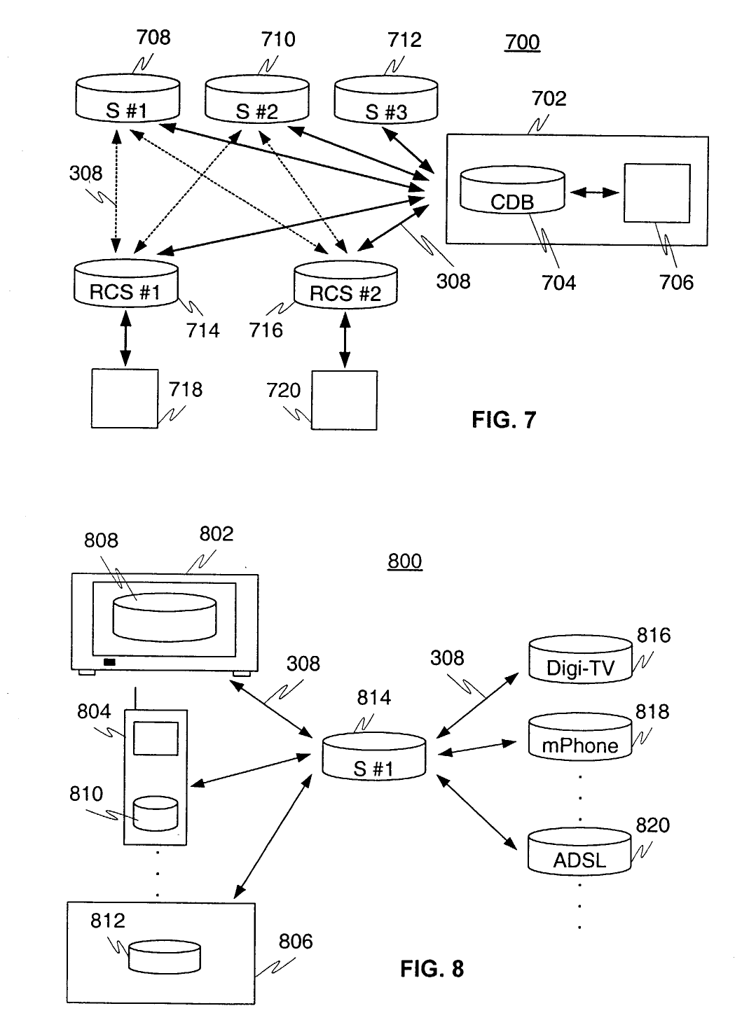

FIG. 7 illustrates a block diagram of an exemplary arrangement 700 for providing the configuration management of the whole arrangement 700 according to one embodiment of the present invention, where the arrangement comprises at least subscriber's database 708, 710, 712, usage record collector server 714, 716 and source 718, 720 of usage records. The configuration of the arrangement 700 is implemented using a separate configuration manager system 702 that may advantageously interface with all subscriber databases and service nodes of the system.

The configuration manager system 702 comprises typically at least one configuration database 704 for collecting and maintaining information, such as configuration information, of the arrangement 700, subscribers and service elements. In addition the configuration manager system 702 comprises also a configuration manager application 706 for administrating, controlling and monitoring the configuration of the arrangement 700. According to the invention the configuration manager system 702 advantageously has a global view of the arrangement 700 and it 702 may also monitor the state and hierarchy of databases 708, 710, 712 of at least part of subscribers as well as condition of the servers where the subscriber databases are maintained. Further the configuration manager system 702 may also monitor the condition or state of the usage record collector servers 714, 716 and sources 718,720 of usage records.

According to one embodiment of the invention the configuration manager system 702 may interface or synchronize configuration information such as database schemas, configuration parameters and application programs with at least part of elements of the arrangement 700 in near real time, whereupon the configuration manager system 702 can make basic database operation, such as statistical conclusions, for the arrangement in real time. Further the configuration manager system 702 may synchronize information with at least part of the elements of the arrangement 700 simultaneously. More detailed description of a configuration management system is disclosed in another U.S. patent application [2] filed by Solid

In addition according to one embodiment of the invention the configuration manager system 702 may administrate the security material of the whole arrangement 700. The configuration manager system 702 may for example administer certificates and public/private key pairs, which are needed for example in an authentication process of servers and in encryption process of transactions between a master and replica.

Furthermore it should be noticed that transferring data between the configuration manager system 702 and other parts of the arrangement 700 may be implemented using synchronization through a data communication network 308, but other methods of reliable data transfer known by a man skilled in the art can be applied as well. Further it should be noticed that transactions or other delivered data may be encrypted for example using disposable keys assigned by the master according to the method disclosed in another U.S. patent application [3] filed by Solid.

FIG. 8 illustrates a block diagram of an exemplary arrangement 800 for self-provisioning subscriber's service portfolio by the subscriber according to one embodiment of the present invention, where each smart terminals, such as a digital television 802, mobile phone 804 and ADSL terminal 806, used by the subscriber can host a copy 808, 810, 812 of appropriate parts of the profile data or personal master database. The master copy of profile data of each terminals or services used by the subscriber may be maintained at the subscriber's personal master database 814 locating for example at a server operated and maintained by the network operator or other trusted party, who is the primary user of the collected usage data.

According to the invention each usage record collector server 816, 818, 820 may collect user preference data relating to said server 816, 818, 820 from the subscriber's personal master database 814 in order to produce right kind of usage data of the data communication network 308 and its elements and performing smart billing for the subscriber based on the subscriber's preference, profile and usage of the services and contents. In FIG. 8 one of the usage record collector servers 816, 818, 820 may be arranged to be compatible for example with digital television, one with mobile phone and one with ADSL services, whereupon each of the usage record collector server 816, 818, 820 collects and maintain data relating only its 816, 818, 820 own role. Now for example the usage record collector server 816 dedicated to digital television services collects usage data only of digital television services and may maintain replica databases for each subscriber of digital television service.

According to the invention the subscriber may change his own preferences or profile for example by modifying the profile data. According to one embodiment of the invention the user may be allowed to self-provision his own service portfolio for example by manipulating the profile data in the user's terminal and synchronizing the changes with the user's master database 814. Alternatively, manipulating or modification of preferences may be done for example through an authorized set of services, where the subscriber can directly access the data of the master database through a this set of services. The applicable part of the modified data, such as changes in the subscriber database, may be automatically pushed to the network elements and usage record collector servers 816, 818, 820 of the services providing the subscribers services using for example data synchronization.

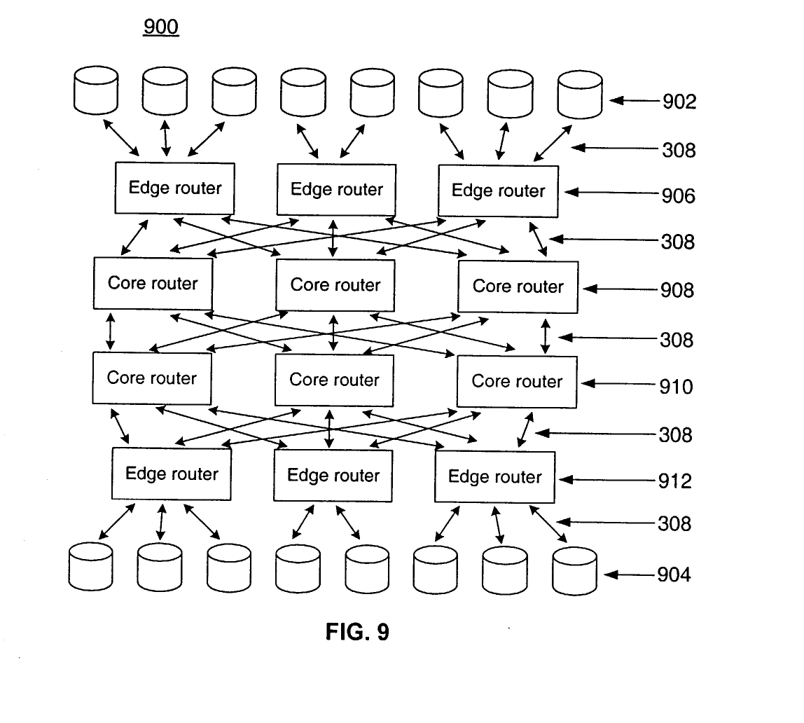

FIG. 9 illustrates a block diagram of an exemplary arrangement 900 for providing data synchronization by utilizing a content routing mechanism according to one embodiment of the present invention, where content routing mechanism is used as a means to efficiently deliver large number of typically small synchronization messages between large number of master 902 and replica 904 databases via an information network 308.

The arrangement 900 illustrates a method, where the replica or master database server 904, 902 can assemble a message, such as service usage monitoring transaction, and send it to its edge router 912, 906 instead of sending it directly to the master or replica database server 902, 904. The edge routers 906, 912, as well as the core routers 910, 908, may aggregate multiple synchronization messages, whose next destination is same router 910, 908 or database server 902, 904, into one message in order to minimize the number of messages travelling between nodes and thus optimise the effectiveness of the information network system. The edge and core routers 906, 908, 910, 912 may be arranged to buffer the delivered messages for a specified wait time in order to wait for some other messages, that have the same next recipient in order to aggregate them into one message and forward to the next router or database server.

According to one embodiment of the invention the master and replica database servers may maintain numbers of databases 902, 904, whereupon the servers may also be arranged to queue the messages to be delivered for a specified wait time in order to wait some other possible messages, that may have the same next recipient in order to aggregate them into same message and forward to the edge router 906, 912.

In some embodiments of the invention the usage record collector nodes and the service nodes are realised in the same network node.

The used information network 308 (illustrated in FIGS. 3, 4, 5, 6, 7, 8 and 9) may for example be wired or wireless information network and it can be implemented to work in a telecommunication system, which is compliant with at least one of the following: TCP/IP, CDMA, GSM, HSCSD, GPRS, WCDMA, EDGE, Bluetooth, UMTS, Teldesic, Iridium, Inmarsat, WLAN, DIGI-TV, and imode.

It is also preferable to use a standardized operating system in the devices, such as those servers, devices and terminals, which administer the master and replica databases in the information network 308. The operating system of devices may be, for example, Unix, MS-Windows, EPOC, NT, MSCE, Linux, VxWorks, ChorusOS, PalmOS, Elate, NetBSD, FreeBSD, OSE and GEOS.

Several advantages of the inventive method and system have been demonstrated and it is clear that it realizes several application opportunities in accordance with the invention. For example the master and replica databases according to the present invention can be managed by any data processing device known by a person skilled in the art, such as for example a computer, a workstation or a mobile station equipped with a suitable means for connecting to the information network. In addition the devices may comprise at least one processor and memory means.

A system according to the invention can be implemented by a person skilled in the art with state of the art of information technology and communication technology components. A person skilled in the art can implement the functions according to the invention by arranging and programming such components to realize the inventive functions.

To a person skilled in the art it is obvious that in order to have an illustrative description the above presented exemplary embodiments have a structure and a function, which are relatively simple. By applying the model presented in this application it is possible to design different and very complicated systems, which in obvious ways to the expert, utilize the inventive idea presented in this application.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

### CITED DOCUMENT:

[1] EP 0 860 788; Intelligent Transaction, Solid Information Technology Oy

[2] U.S. patent application Ser. No. 09/851,478; Method and Arrangement for the Management of Database Schemas, Solid Information Technology Oy

[3] U.S. patent application Ser. No. 09/846,107; Method and arrangement for secure synchronized transactions, Solid Information Technology Oy

1. A method for network data management, where at least one user has at least one personal master database dedicated to the user, characterized in that at least some of the service usage data of said user is managed by said personal master database.

2. A method according to claim 1, characterized in that said personal master database manages at least some of the user profile data of said user.

3. A method according to claim 1, characterized in that said personal database dedicated to the user is provided with personal access rights.

4. A method according to claim 1, characterized in that said user is at least one of the following: an individual subscriber and group comprising few subscribers that are treated as one user.

5. A method according to claim 1, characterized in that number of said personal databases is scaled as a function of number of users.

6. A method according to claim 1, characterized in that a usage record collector server can directly access and modify the data of the personal master database.

7. A method according to claim 1, characterized in that at least partial replica database of said personal master database is created in at least one other database server.

8. A method according to claim 7, characterized in that at least part of the user's profile data is synchronized between the said master and replica databases.

9. A method according to claim 7, characterized in that service usage records are collected to said replica database by a usage record collector server.

10. A method according to claim 9, characterized in that the said usage record collector server obtains usage records from at least one service the said user is using.

11. A method according to claim 9, characterized in that the said usage records are further processed in the said replica database using said user's profile data.

12. A method according to claims 9 and 11, characterized in that at least part of said processed or unprocessed usage records are transferred from the replica database to the personal master database.

13. A method according to claim 9, characterized in that service usage records for the users are generated by at least one of the following sources: IP Edge Router, Phone or Telecom Switch, Web Service and e-business servers.

14. A method according to claim 1, where said database is a personal master database, characterized in that any related changes in the user's personal master database are automatically sent to the replica databases of usage record collectors of network elements and servers providing the user services.

15. A method according to claim 13, characterized in that data is delivered between master and replica databases using data synchronization.

16. A method according to claim 14, characterized in that data is synchronized using content routing, where a number of data messages, whose next destination address is same, are aggregated into one message.

17. A method according to claim 14, characterized in that delivered data between the master and replica databases is encrypted using at least one disposable key assigned by the master.

18. A method according to claim 1, characterized in that the user is allowed to self-provision his own service portfolio, preferences or profile by manipulating the data of said personal master database through a set of services.

19. A method according to claim 1, characterized in that configuration of the master and replica databases and their related applications is managed by a separate configuration management system, which has a global view of at least part of the network arrangement.

20. A method according to claim 1, characterized in that said database comprises information relating to at least one of the following: user profile data, user preferences, user-specific service rating, user's terminal, terminal address or number, terminal IP-number, bandwidth, bandwidth in different time of day and quality of service.

21. A method according to claim 1, characterized in that user profile data affects the content of said service usage data to be collected to the said personal database and the way of collecting said service usage data.

22. A method according to claim 1, characterized in that the user profile data contains at least one piece of computer executable program that performs at least one data collection or processing task in the personal master database.

23. A method according to claim 1, characterized in that the user profile data contains at least one piece of computer executable program that performs at least one data collection or processing task in the record collector server.

24. A method according to claim 1, characterized in that billing of network services and contents is based on the collected usage data and profile of the user who uses the services.

25. A method according to claim 1, characterized in that monitoring, managing and billing of services is performed in near real time.

26. A method according to the claim 1, characterized in that the method is compatible with at least one of the following communication specifications: TCP/IP, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

27. A method according to the claim 1, characterized in that at least one of the following operating systems is used in at least one terminal comprising at least one of the databases of the database system: Unix, MS-windows, EPOC, NT, MSCE, Linux, PalmOS and GEOS.

28. A method according to the claim 1, characterized in that at least one of the following operating systems is used in at least one server comprising at least one of the databases of the database system: Unix, MS-windows, and Linux.

29. A network data management arrangement comprising at least one user with at least one personal dedicated master database, characterized in that said personal master database is arranged to manage at least some of the service usage data of said user.

30. A network data management arrangement according to claim 29, characterized in that said personal master database is arranged to manage at least some of the user profile data of said user.

31. A network data management arrangement according to claim 29, characterized in that said personal database dedicated to the user is provided with personal access rights.

32. A network data management arrangement according to claim 29, characterized in that said user is at least one of the following: an individual subscriber and group comprising few subscribers that are treated as a one user.

33. A network data management arrangement according to claim 29, characterized in that number of said personal databases is arranged to be scalable as a function of number of users using the service.

34. A network data management arrangement according to claim 29, characterized in that at least partial replica database of said personal master database is created in at least one other database server.

35. A network data management arrangement according to claim 33, characterized in that, at least part of the user's profile data is synchronized between the said master and replica databases.

36. A network data management arrangement according to claim 33, characterized in that, at least some of the service usage records are collected to said replica database by a usage record collector server.

37. A network data management arrangement according to claim 33, characterized in that the said usage record collector server obtains usage records from at least one service the said user is using.

38. A network data management arrangement according to claim 29, characterized in that the user profile data contains at least one piece of computer executable program that performs at least one data collection or processing task in the personal master database.

39. A network data management arrangement according to claim 29, characterized in that the user profile data contains at least one piece of computer executable program that performs at least one data collection or processing task in the record collector server

40. A network data management arrangement according to claim 29, characterized in that service usage records for the users are generated by at least one of the following sources: IP Edge Router, Phone or Telecom Switch, Web Service and e-business servers.

41. A network data management arrangement according to claim 29, characterized in that said database comprises information relating to at least one of the following: user profile data, user preferences, user-specific service rating, user's terminal, terminal address or number, terminal IP-number, bandwidth, bandwidth in different time of day and quality of service.

42. A network data management arrangement according to claim 29, characterized in that the arrangement is compatible with at least one of the following communication specifications: TCP/IP, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

43. A network data management arrangement according to claim 29, characterized in that the database servers are provided in a terminal, which is at least one of the following: a mobile station, a computer, a workstation, terminal connected with modem, LAN card or DSL service, personal digital assistant and digital television.

44. A network data management arrangement according to claim 29, characterized in that the terminal has at least one of the following operating systems: Unix, MS-windows, EPOC, NT, MSCE, Linux, PalmOS and GEOS.

45. A database server comprising at least one personal dedicated master database for a dedicated user, characterized in that said personal master database is arranged to manage at least some of the service usage data of said user.

46. A database server according to claim 45, characterized in that said personal master database is arranged to manage at least some of the user profile data of said user.

47. A database server according to claim 45, characterized in that said personal database dedicated to the user is provided with personal access rights.

48. A database server according to claim 45, characterized in that the server is arranged to scale the number of said personal databases as a function of number of users using the service.

49. A database server according to claim 45, characterized in that the server is arranged to maintain master and/or replica databases distributed to several or at least one server.

50. A database server according to claim 45, characterized in that the database server is arranged to be in data connection with at least one of the following means: usage record collector server, IP Edge Router, Phone or Telecom Switch and e-business servers.

51. A database server according to claim 45, characterized in that the database server is arranged to encrypt transactions and delivered data using at least one disposable key assigned by the master.

52. A database server according to claim 45, characterized in that the database server is arranged to deliver user profile data at least partly to network elements providing the user services.

53. A database server according to claim 45, characterized in that the database server is compatible with at least one of the following communication specifications: TCP/IP, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

54. A database server according to claim 45, characterized in that the database servers are provided in a terminal, which is at least one of the following: a mobile station, a computer, a workstation, terminal connected with modem, LAN card or DSL service, personal digital assistant and digital television.

55. A database server according to claim 45, characterized in that the terminal has at least one of the following operating systems: Unix, MS-windows, EPOC, NT, MSCE, Linux, PalmOS and GEOS.

56. A database server according to claim 45, characterized in that said database comprises information relating to at least one of the following: user profile data, user preferences, user-specific service rating, user's terminal, terminal address or number, terminal IP-number, bandwidth, bandwidth in different time of day and quality of service.
